(19) United States
(12) Patent Application Publication
(10) Pub. No.: US 2002/0086165 A1
(43) Pub. Date: Jul. 4, 2002

(54) Metal matrix composites and methods for making the same

(76) Inventors: Sarah J. Davis, Harvest, AL (US); Scott R. Hollway, North St. Paul, MN (US); William J. Satzer JR., Eagan, MN (US); John D. Skildum, North Oaks, MN (US); Larry R. Visser, Oakdale, MN (US); Ernest R. Waite, River Falls, WI (US)

Correspondence Address: Office of Intellectual Property Counsel, 3M Innovative Properties Company, P.O. Box 33427, St. Paul, MN, 55133-3427, US

(21) Appl. No.: 09/967,562

(22) Filed: Sep. 27, 2001

Related U.S. Application Data
(60) Provisional application No. 60/236,110, filed on Sep. 28, 2000.

(51) Int. Cl. B32B 3/00

(52) U.S. Cl. 428/446; 428/210; 428/469; 428/697

(57) ABSTRACT

Metal matrix composites reinforced with ceramic oxide pre-forms.

This application claims priority to U.S. Provisional Patent Application No. 60/236,110, filed Sep. 28, 2000, the disclosure of which is incorporated herein by reference.

### FIELD OF THE INVENTION

The present invention pertains to and metal matrix composites reinforced with ceramic oxide pre-forms comprising substantially continuous, ceramic oxide fibers.

### BACKGROUND OF THE INVENTION

The reinforcement of metal matrices with ceramics is known in the art (see, e.g., U.S. Pat. Nos. 4,705,093 (Ogino), 4,852,630 (Hamajima et al.), 4,932,099 (Corwin et al.), 5,199,481 (Corwin et al.), 5,234,080 (Pantale) and 5,394,930 (Kennerknecht), and Great Britain Pat. Doc. Nos. 2,182,970 A and B, published May 28, 1987 and Sep. 14, 1988, respectively). Examples of ceramic materials used for reinforcement include particles, discontinuous fibers (including whiskers) and continuous fibers, as well as ceramic pre-forms.

Typically, ceramic material is incorporated into a metal, thereby creating a metal matrix composite (MMC) to improve the mechanical properties of an article made of the metal. For example, conventional brake calipers for motorized vehicles (e.g., cars and trucks) are typically made of cast iron. To reduce the overall weight of the vehicle, as well as in particular unsprung weight such as brake calipers, there is a desire to use lighter weight parts and/or materials. One technique for aiding in the design of MMCs, including placement of the ceramic oxide material and minimizing the amount of ceramic oxide material needed for the particular application, is finite element analysis.

A brake caliper made of cast aluminum would be about 50 percent by weight lighter than the same (i.e., the same size and configuration) caliper made of cast iron. The mechanical properties of cast aluminum and cast iron are not the same (e.g., the Young's modulus of cast iron is about 100-170 GPa, while for cast aluminum it is about 70-75 GPa; the yield strength of cast iron is 200-500 MPa, while for cast aluminum it is 150-170 MPa). Hence, a brake caliper made from cast aluminum has significantly lower mechanical properties such as bending stiffness and yield strength than the cast iron caliper. Typically, the mechanical properties of such an aluminum brake caliper are unacceptably low as compared to a cast iron brake caliper having the same size and shape. A brake caliper made of an aluminum metal matrix composite material (e.g., aluminum reinforced with ceramic fibers) that had the same configuration and at least the same (or better) mechanical properties, such as bending stiffness and yield strength, as a cast iron brake caliper is desirable.

One consideration for some MMC articles is the need for post-formation machining (e.g., adding holes or threads, or otherwise cutting away material to provide a desired shape) or other processing (e.g., welding two MMC articles together to make a complex shaped part). Conventional MMCs typically contain enough ceramic reinforcement material to make machining or welding impractical or even impossible. Hence, it is desirable to produce “net-shaped” articles that require little, if any, post-formation machining or processing. Techniques for making “net-shaped” articles are known in the art (see, e.g., U.S. Pat. Nos. 5,234,045 (Cisko) and 5,887,684 (Döll et al.)). In addition, or alternatively, to the extent feasible, the ceramic reinforcement may be reduced or not placed in areas will it interfere with machining or other processing such as welding.

Another consideration in designing and making MMCs is the cost of the ceramic reinforcement material. The mechanical properties of continuous polycrystalline alpha-alumina fibers such as that marketed the 3M Company, St. Paul, Minn., under the trade designation “NEXTEL 610”, are high compared to low density metals such as aluminum. In addition, the cost of ceramic oxide materials such as the polycrystalline alpha-alumina fibers, is substantially more than metals such as aluminum. Hence, it is desirable to minimize the amount of ceramic oxide material used, and to optimize the placement of the ceramic oxide materials in order to maximize the properties imparted by the ceramic oxide materials.

Further, it is desirable to provide the ceramic reinforcement material in a package or form, such as a porous ceramic pre-form, that can be relatively easily used to make a metal matrix composite article therefrom.

### SUMMARY OF THE INVENTION

In one aspect, the present invention provides porous ceramic oxide (e.g., calcined or sintered) pre-forms comprising substantially continuous ceramic oxide (i.e., glass, crystalline ceramic, and combinations thereof) fibers for making metal matrix composite articles. In another aspect, the present invention provides metal matrix composite articles comprising at least one porous ceramic oxide pre-form (including porous ceramic oxide pre-forms according to the present invention) comprising substantially continuous ceramic oxide fibers.

Typically, the substantially continuous ceramic oxide fibers have lengths of at least 5 cm (frequently at least 10 cm, 15 cm, 20 cm, 25 cm, or more). In some embodiments of the present invention, the substantially continuous ceramic oxide fibers are in the form of tows (i.e., the tows are comprised of the substantially continuous ceramic oxide fibers). Typically, the substantially continuous ceramic oxide fibers comprising the tow have lengths of at least 5 cm (frequently at least 10 cm, 15 cm, 20 cm, 25 cm, or more), although their lengths may also be less 5 cm.

Preferably, the porous ceramic oxide pre-form, which extends along at least a portion of the length of the substantially continuous ceramic oxide fibers, comprises porous ceramic oxide material securing the ceramic oxide fibers in place. In another aspect, the ceramic oxide fibers can include, or even consist essentially of, substantially continuous, longitudinally aligned, ceramic oxide fibers, wherein “longitudinally aligned” refers to the generally parallel alignment of the fibers relative to the length of the fibers. Optionally, the fibers are encapsulated within the porous ceramic oxide material.

In some embodiments according to the present invention, the substantially continuous ceramic oxide fibers have a first Young's modulus, and ceramic oxide material comprising the ceramic perform has a second Young's modulus, wherein the first Young's modulus is greater than the second Young's modulus.

One porous ceramic oxide pre-form for making metal matrix composite articles according to the present invention comprises porous ceramic oxide material securing ceramic oxide fibers in place, wherein the porous ceramic oxide material extends along at least a portion of the length of the fibers, wherein the ceramic oxide fibers consist essentially of substantially continuous, longitudinally aligned, ceramic oxide fibers. Optionally, the fibers are encapsulated within the porous ceramic oxide material.

Embodiments of porous ceramic oxide pre-form for making metal matrix composite articles according to the present invention include, for example, porous ceramic oxide material having an open porosity (as measured as described below), in increasing order of preference, of at least 20% (typically in the range of 20% to 95%, more typically in the range from 25% to 95%, preferably, at least 50%, more preferably, in the range from 50% to 90%, even more preferably, at least 85%, and most preferably, in the range from 85% to 95%) by volume, securing substantially continuous, longitudinally aligned, ceramic oxide fibers in place, wherein the porous ceramic oxide material extends along at least a portion of the length of the fibers. Optionally, the fibers are encapsulated within the porous ceramic oxide material.

A method for making a porous ceramic oxide pre-form comprises:

positioning at least one elongated fiber insert in a cavity, the fiber insert comprising substantially continuous, longitudinally aligned, ceramic oxide fibers;

introducing a slurry into the cavity such that a pre-determined portion of the elongated fiber insert is coated with the slurry, the slurry comprising liquid medium and discontinuous ceramic oxide fibers (including whiskers) dispersed therein;

removing a sufficient amount of the liquid medium to cause the discontinuous fibers to consolidate and secure the fiber insert to provide an article comprising the elongated fiber insert and the discontinuous fibers (including whiskers), wherein the consolidation of discontinuous fibers extends along at least a portion of the length of the fiber insert;

drying the consolidated article to provide a green ceramic oxide pre-form comprising the elongated fiber insert and the discontinuous ceramic oxide fibers, wherein at least one consolidation of the discontinuous fibers secures the fiber insert in place, wherein the consolidation of discontinuous fibers extends along at least a portion of the length of the fiber insert; and

heating the green ceramic oxide pre-form to at least one temperature sufficient to provide a porous ceramic oxide pre-form comprising porous ceramic oxide material securing the substantially continuous, longitudinally aligned, ceramic oxide fibers in place, wherein the porous ceramic oxide material extends along at least a portion of the length of the fibers.

A method for making a porous ceramic oxide pre-form comprises:

positioning at least one elongated fiber insert in a cavity, the fiber insert comprising substantially continuous, longitudinally aligned, ceramic oxide fibers;

introducing a slurry into the cavity such that a pre-determined portion of the elongated fiber insert is coated with the slurry, the slurry comprising liquid medium and discontinuous ceramic oxide fibers (including whiskers) dispersed therein;

removing a sufficient amount of the liquid medium to cause the discontinuous fibers to consolidate and secure the fiber insert to provide an article comprising the elongated fiber insert and the discontinuous fibers, wherein the consolidation of the discontinuous fibers extends along at least a portion of the length of the fiber insert; and

heating the green ceramic oxide pre-form to at least one temperature sufficient to provide a porous ceramic oxide pre-form comprising porous ceramic oxide material securing the substantially continuous, longitudinally aligned, ceramic oxide fibers in place, wherein the porous ceramic oxide material extends along at least a portion of the length of the fibers.

In one embodiment, the present invention provides a method for making a porous ceramic oxide for an article comprising metal matrix material, the method comprising:

designing an article to comprise metal matrix composite material reinforced, at least in part, with at least two plies comprised of substantially continuous, longitudinally aligned, ceramic oxide fibers having lengths of at least 5 cm, wherein the metal matrix composite material to comprise at least one ceramic oxide pre-form comprising porous ceramic oxide material extends along at least a portion of the respective lengths of the substantially continuous, longitudinally aligned, ceramic oxide fibers, wherein first and second plies comprised of the substantially continuous, longitudinally aligned, ceramic oxide fibers have lengths that extend in a first and second direction, respectively, wherein the first and second directions are oriented in the range from greater than 0° to 90° with respect to one another, and wherein the substantially continuous, longitudinally aligned, ceramic oxide fibers have a first Young's modulus and the ceramic oxide material has a second Young's modulus, and wherein the first Young's modulus is greater than the second Young's modulus; and

preparing, based on the resulting design, a porous ceramic oxide pre-form comprising the porous ceramic oxide material securing the plies comprised of the substantially continuous, ceramic oxide fibers in place, wherein the ceramic oxide material extends along at least a portion of the respective lengths of the substantially continuous, longitudinally aligned, ceramic oxide fibers, and wherein the first and second directions are oriented in the range from greater than 0° to 90° with respect to one another.

In another embodiment, the present invention provides a method for making a porous ceramic oxide for an article comprising metal matrix material, the method comprising:

designing an article to comprise metal matrix composite material reinforced, at least in part, with at least two plies each comprised of substantially continuous, longitudinally aligned, ceramic oxide fibers, wherein the metal matrix composite material to comprise at least one ceramic oxide pre-form comprising porous ceramic oxide material extends along at least a portion of the respective lengths of the tows comprised of substantially continuous, longitudinally aligned, ceramic oxide fibers, wherein first and second plies each comprised of tows comprised of substantially continuous, longitudinally aligned, ceramic oxide fibers have lengths that extend in a first and second direction, respectively, wherein the first and second directions are oriented in the range from greater than 0° to 90° with respect to one another, and wherein the substantially continuous, longitudinally aligned, ceramic oxide fibers have a first Young's modulus and the ceramic oxide material has a second Young's modulus, and wherein the first Young's modulus is greater than the second Young's modulus; and

preparing, based on the resulting design, a porous ceramic oxide pre-form comprising the porous ceramic oxide material securing the plies comprised of tows comprised of the substantially continuous, ceramic oxide fibers in place, wherein the ceramic oxide material extends along at least a portion of the length of the substantially continuous ceramic oxide fibers, and wherein the first and second directions are oriented in the range from greater than 0° to 90° with respect to one another.

In another embodiment, the present invention provides a method for making a porous ceramic oxide for an article comprising metal matrix material, the method comprising:

designing an article to comprise metal matrix composite material reinforced, at least in part, with at least two plies comprised of substantially continuous, longitudinally aligned, ceramic oxide fibers having lengths of at least 5 cm, wherein the metal matrix composite material to comprise at least one ceramic oxide pre-form comprising porous ceramic oxide material extends along at least a portion of the respective lengths of the substantially continuous, longitudinally aligned, ceramic oxide fibers, wherein first and second plies comprised of the substantially continuous, longitudinally aligned, ceramic oxide fibers have lengths that extend in a first and second direction, respectively, wherein the first and second directions are oriented in the range from greater than 0° to 90° with respect to one another, and wherein the substantially continuous, longitudinally aligned, ceramic oxide fibers have a first Young's modulus and the ceramic oxide material has a second Young's modulus, and wherein the first Young's modulus is greater than the second Young's modulus; and

preparing, based on the resulting design, a porous ceramic oxide pre-form comprising the porous ceramic oxide material having an open porosity of at least 85% by volume securing the plies comprised of the substantially continuous ceramic oxide fibers in place, wherein the ceramic oxide material extends along at least a portion of the respective lengths of the of substantially continuous, longitudinally aligned, ceramic oxide fibers, and wherein the first and second directions are oriented in the range from greater than 0° to 90° with respect to one another.

In another embodiment, the present invention provides a method for making a porous ceramic oxide for an article comprising metal matrix material, the method comprising:

designing an article to comprise metal matrix composite material reinforced, at least in part, with at least two plies comprised of substantially continuous, longitudinally aligned, ceramic oxide fibers, wherein the metal matrix composite material to comprise at least one ceramic oxide pre-form comprising porous ceramic oxide material extends along at least a portion of the respective lengths of the tows comprised of substantially continuous, longitudinally aligned, ceramic oxide fibers, wherein first and second plies each comprised of tows comprised of substantially continuous, longitudinally aligned, ceramic oxide fibers have lengths that extend in a first and second direction, respectively, wherein the first and second directions are oriented in the range from greater than 0° to 90° with respect to one another, and wherein the substantially continuous, longitudinally aligned, ceramic oxide fibers have a first Young's modulus and the first ceramic oxide material has a second Young's modulus, and wherein the first Young's modulus is greater than the second Young's modulus; and

preparing, based on the resulting design, a porous ceramic oxide pre-form comprising the porous ceramic oxide material having an open porosity of at least 85% by volume securing the plies comprised of the tows comprised of the substantially continuous ceramic oxide fibers in place, wherein the ceramic oxide material extends along at least a portion of the length of the ceramic oxide fibers, and wherein the first and second directions are oriented in the range from greater than 0° to 90° with respect to one another.

In another embodiment, the present invention provides a method for making a porous ceramic oxide for an article comprising metal matrix material, the method comprising:

designing an article to comprise metal matrix composite material reinforced, at least in part, with at least two plies comprised of substantially continuous, longitudinally aligned, ceramic oxide fibers having lengths of at least 5 cm, wherein first and second plies comprised of the substantially continuous, longitudinally aligned, ceramic oxide fibers have lengths that extend in a first and second direction, respectively, and wherein the first and second directions are oriented in the range from greater than 0° to 90° with respect to one another;

preparing, based on the resulting design, an elongated pre-form comprising the plies comprised of substantially continuous, longitudinally aligned, ceramic oxide fibers and binder material bonding substantially continuous, longitudinally aligned, ceramic oxide fibers together, wherein the first and second directions are oriented in the range from greater than 0° to 90° with respect to one another;

preparing a green ceramic oxide pre-form comprising green ceramic oxide material extending along at least a portion of the length of the elongated pre-form; and

heating the green ceramic oxide pre-form to provide a porous ceramic oxide pre-form comprising ceramic oxide material securing the plies comprised of substantially continuous, longitudinally aligned, ceramic oxide fibers in place, wherein the ceramic oxide material extends along at least a portion of the lengths of the plies, and wherein the first and second directions are oriented in the range from greater than 0° to 90° with respect to one another.

In another embodiment, the present invention provides a method for making a porous ceramic oxide for an article comprising metal matrix material, the method comprising:

designing an article to comprise metal matrix composite material reinforced, at least in part, with at least two plies comprised of substantially continuous, longitudinally aligned, ceramic oxide fibers;

preparing, based on the resulting design, an elongated pre-form comprising the two plies comprised of tows comprised of the substantially continuous, longitudinally aligned, ceramic oxide fibers and binder material bonding tows comprised of substantially continuous, longitudinally aligned, ceramic oxide fibers together, wherein first and second plies each comprised of tows comprised of substantially continuous, longitudinally aligned, ceramic oxide fibers have lengths that extend in a first and second direction, respectively, and wherein the first and second directions are oriented in the range from greater than 0° to 90° with respect to one another;

preparing a green ceramic oxide pre-form comprising green ceramic oxide material extending along at least a portion of the length of the elongated pre-form; and

heating the green ceramic oxide pre-form to provide a porous ceramic oxide pre-form comprising porous ceramic oxide material securing the plies comprised of the tows comprised of the substantially continuous, longitudinally aligned, substantially continuous ceramic oxide fibers in place, wherein the ceramic oxide material extends along at least a portion of the length of the substantially continuous ceramic oxide fibers, and wherein the first and second directions are oriented in the range from greater than 0° to 90° with respect to one another.

In another embodiment, the present invention provides a method for making a porous ceramic oxide for an article comprising metal matrix material, the method comprising:

designing an article to comprise metal matrix composite material reinforced, at least in part, with at least two plies comprised of substantially continuous, longitudinally aligned, ceramic oxide fibers having lengths of at least 5 cm, wherein first and second plies comprised of the substantially continuous, longitudinally aligned, ceramic oxide fibers have lengths that extend in a first and second direction, respectively, and wherein the first and second directions are oriented in the range from greater than 0° to 90° with respect to one another,

preparing, based on the resulting design, an elongated pre-form comprising the plies comprised of substantially continuous, longitudinally aligned, ceramic oxide fibers and binder material bonding substantially continuous, longitudinally aligned, ceramic oxide fibers together, wherein the first and second directions are oriented in the range from greater than 0° to 90° with respect to one another;

preparing a green ceramic oxide pre-form comprising green ceramic oxide material extending along at least a portion of the length of the elongated pre-form; and

heating the green ceramic oxide pre-form to provide a porous ceramic oxide pre-form comprising ceramic oxide material having an open porosity of at least 85% by volume securing the plies comprised of the substantially continuous, longitudinally aligned, ceramic oxide fibers in place, wherein the ceramic oxide material extends along at least a portion of the respective lengths of the substantially continuous, longitudinally aligned, ceramic oxide fibers, and wherein the first and second directions are oriented in the range from greater than 0° to 90° with respect to one another.

In another embodiment, the present invention provides a method for making a porous ceramic oxide for an article comprising metal matrix material, the method comprising:

designing an article to comprise metal matrix composite material reinforced, at least in part, with at least two plies each comprised of substantially continuous, longitudinally aligned, ceramic oxide fibers, wherein first and second plies each comprised of tows comprised of substantially continuous, longitudinally aligned, ceramic oxide fibers have lengths that extend in a first and second direction, respectively, and wherein the first and second directions are oriented in the range from greater than 0° to 90° with respect to one another;

preparing, based on the resulting design, an elongated pre-form comprising the at least two plies comprised of tows comprised of the substantially continuous, longitudinally aligned, ceramic oxide fibers and binder material bonding tows comprised of substantially continuous, longitudinally aligned, ceramic oxide fibers together, wherein the first and second directions are oriented in the range from greater than 0° to 90° with respect to one another;

preparing a green ceramic oxide pre-form comprising green ceramic oxide material extending along at least a portion of the length of the elongated pre-form; and

heating the green ceramic oxide pre-form to provide a porous ceramic oxide pre-form comprising porous ceramic oxide material having an open porosity of at least 85% by volume securing the substantially continuous, longitudinally aligned, ceramic oxide fibers in place, wherein the ceramic oxide material extends along at least a portion of the length of the substantially continuous ceramic oxide fibers, and wherein the first and second directions are oriented in the range from greater than 0° to 90° with respect to one another.

In another embodiment, the present invention provides a metal matrix composite article comprising a porous ceramic oxide and metal matrix material, wherein the ceramic oxide pre-form comprises first and second plies each comprised of substantially continuous ceramic oxide fibers having lengths of at least 5 cm and a porous ceramic oxide material extending along at least a portion of the respective lengths of the substantially continuous, longitudinally aligned, ceramic oxide fibers, wherein the substantially continuous, longitudinally aligned, ceramic oxide fibers in the first and second plies have lengths that extend in a first and second direction, respectively, wherein the first and second directions are oriented in the range from greater than 0° to 90° with respect to one another, and wherein the porous ceramic oxide material is infiltrated with at least a portion of the metal matrix material.

In another embodiment, the present invention provides a metal matrix composite article comprising a porous ceramic oxide and metal matrix material, wherein the ceramic oxide pre-form comprises at least two plies comprised of tows comprised of substantially continuous ceramic oxide fibers and a porous ceramic oxide material extending along at least a portion of the respective lengths of the tows comprised of substantially continuous, longitudinally aligned, ceramic oxide fibers, wherein first and second plies each comprised of tows comprised of substantially continuous, longitudinally aligned, ceramic oxide fibers have lengths that extend in a first and second direction, respectively, wherein the first and second directions are oriented in the range from greater than 0° to 90° with respect to one another, and wherein the porous ceramic oxide material is infiltrated with at least a portion of the metal matrix material.

In another embodiment, the present invention provides a metal matrix composite article comprising a porous ceramic oxide and metal matrix material, wherein the ceramic oxide pre-form comprises first and second plies each comprised of substantially continuous, longitudinally aligned, ceramic oxide fibers having lengths of at least 5 cm and a porous ceramic oxide material having an open porosity of at least 85% by volume extending along at least a portion of the respective lengths of the substantially continuous, longitudinally aligned, ceramic oxide fibers, wherein the substantially continuous, longitudinally aligned, ceramic oxide fibers in the first and second plies have lengths that extend in a first and second direction, respectively, wherein the first and second directions are oriented in the range from greater than 0° to 90° with respect to one another, and wherein the porous ceramic oxide material is infiltrated with at least a portion of the metal matrix material.

In another embodiment, the present invention provides a metal matrix composite article comprising a porous ceramic oxide and metal matrix material, wherein the ceramic oxide pre-form comprises first and second plies each comprised of tows comprised of ceramic oxide fibers and a porous ceramic oxide material having an open porosity of at least 85% by volume extending along at least a portion of the respective lengths of the tows comprised of substantially continuous, longitudinally aligned, ceramic oxide fibers, wherein the substantially continuous, longitudinally aligned, ceramic oxide fibers in the first and second plies have lengths that extend in a first and second direction, respectively, wherein the first and second directions are oriented in the range from greater than 0° to 90° with respect to one another, and wherein the porous ceramic oxide material is infiltrated with at least a portion of the metal matrix material.

In another embodiment, the present invention provides a metal matrix composite article comprising a porous ceramic oxide and metal matrix material, wherein the ceramic oxide pre-form comprises:

a first porous ceramic article including an aperture for receiving a porous ceramic oxide; and

a second ceramic article positioned in the aperture, the second ceramic article comprising porous ceramic oxide material and first and second plies each comprised of substantially continuous, longitudinally aligned, ceramic oxide fibers having lengths of at least 5 cm, the porous ceramic oxide material securing the substantially continuous ceramic oxide fibers in place, wherein the porous ceramic oxide material extends along at least a portion of the respective lengths of the substantially continuous, longitudinally aligned, ceramic oxide fibers, wherein the substantially continuous, longitudinally aligned, ceramic oxide fibers in the first and second plies have lengths that extend in a first and second direction, respectively, and wherein the first and second directions are oriented in the range from greater than 0° to 90° with respect to one another,

and wherein the porous ceramic oxide material is infiltrated with at least a portion of the metal matrix material.

In another embodiment, the present invention provides a metal matrix composite article comprising a porous ceramic oxide and metal matrix material, wherein the ceramic oxide pre-form comprises:

a first porous ceramic article including an aperture for receiving a porous ceramic oxide; and

a second ceramic article positioned in the aperture, the second ceramic article comprising porous ceramic oxide material securing at least two plies each comprised of tows comprised of substantially continuous ceramic oxide fibers in place, wherein the porous ceramic oxide material extends along at least a portion of the respective lengths of the tows comprised of substantially continuous, longitudinally aligned, ceramic oxide fibers, wherein first and second plies each comprised of tows comprised of tows comprised of substantially continuous have lengths that extend in a first and second direction, respectively, and wherein the first and second directions are oriented in the range from greater than 0° to 90° with respect to one another, and

wherein the porous ceramic oxide material is infiltrated with at least a portion of the metal matrix material.

In another embodiment, the present invention provides a metal matrix composite article comprising a porous ceramic oxide and metal matrix, wherein the ceramic oxide pre-form comprises:

a first porous ceramic article including an aperture for receiving a porous ceramic oxide; and

a second ceramic article positioned in the aperture, the second ceramic article comprising porous ceramic oxide material having an open porosity of at least 85% by volume and first and second plies each comprised of substantially continuous, longitudinally aligned, ceramic oxide fibers having lengths of at least 5 cm, the porous ceramic oxide material securing the plies comprised of the substantially continuous, ceramic oxide fibers in place, wherein the porous ceramic oxide material extends along at least a portion of the respective lengths of the substantially continuous, longitudinally aligned, ceramic oxide fibers, wherein the substantially continuous, longitudinally aligned, ceramic oxide fibers in the first and second plies have lengths that extend in a first and second direction, respectively, and wherein the first and second directions are oriented in the range from greater than 0° to 90° with respect to one another,

and wherein the porous ceramic oxide material is infiltrated with at least a portion of the metal matrix material.

In another aspect, the present invention provides a metal matrix composite article comprising a porous ceramic oxide and metal matrix, wherein the ceramic oxide pre-form comprises:

a first porous ceramic article including an aperture for receiving a porous ceramic oxide; and

a second ceramic article positioned in the aperture, the second ceramic article comprising porous ceramic oxide material having an open porosity of at least 85% by volume securing at least two plies each comprised of tows substantially continuous, longitudinally aligned, ceramic oxide fibers in place, wherein the porous ceramic oxide material extends along at least a portion of the respective lengths of the tows comprised of substantially continuous, longitudinally aligned, ceramic oxide fibers, wherein first and second plies each comprised of tows comprised of substantially continuous, longitudinally aligned, ceramic oxide fibers have lengths that extend in a first and second direction, respectively, and wherein the first and second directions are oriented in the range from greater than 0° to 90° with respect to one another,

and wherein the porous ceramic oxide material is infiltrated with at least a portion of the metal matrix material.

One advantage of an aspect of the present invention is that it allows for an existing article made of one metal (e.g., cast iron) to be redesigned to be made from another metal (e.g., aluminum) reinforced with ceramic oxide material including substantially continuous, ceramic oxide fibers such that the latter (i.e., the metal matrix composite version of the article) has certain desired properties (e.g., Young's modulus, yield strength, and ductility) at least equal to that required for the use of the original article made from the first metal. Optionally, the article may be redesigned to have the same physical dimensions as the original article.

### BRIEF DESCRIPTION OF THE DRAWING

FIG. 1 is a perspective view of a porous ceramic oxide pre-form.

FIG. 2 is a perspective view of a ceramic fiber ribbon used to make a porous ceramic oxide pre-form.

FIG. 3 is a perspective view of an apparatus for making ceramic oxide pre-forms.

FIG. 4 is a perspective view of another ceramic oxide pre-form.

FIG. 5 is a perspective view of a brake caliper according to the present invention.

FIG. 6 is a perspective view of another brake caliper according to the present invention.

FIG. 7 is a digital SEM photomicrograph of a polished cross-section of a fracture surface of a portion of a brake caliper according to the present invention.

FIGS. 8 and 9 are digital SEM photomicrographs of a fracture surface of a portion of a brake caliper according to the present invention.

FIG. 10 is a perspective view of a porous ceramic oxide pre-form.

FIG. 11 is a perspective view of a metal matrix composite article made from the porous ceramic oxide pre-form shown in FIG. 10.

FIG. 12 is a perspective view of an alternative pre-form utilizing multiple ply of longitudinally aligned alpha alumina fibers wherein the longitudinal axises of the ply are positioned at an angle greater than zero relative to one another.

FIG. 13 is a perspective view of a grouping of substantially continuous alpha alumina fibers spirally wrapped with another group of substantially continuous alpha alumina fibers.

### DETAILED DESCRIPTION OF PREFERRED EMBODIMENTS

The present invention provides metal matrix composite articles comprising at least one ceramic oxide pre-form comprising substantially continuous ceramic oxide fibers. Preferably, metal matrix composite articles according to the present invention are designed for the particular application to achieve an optimal, or at least acceptable balance of desired properties, low cost, and ease of manufacture.

Typically, a porous ceramic oxide(s) is designed for a specific application and/or to have certain properties and/or features. For example, an existing article made of one metal (e.g., cast iron) is selected to be redesigned to be made from another metal (e.g., aluminum) reinforced with ceramic oxide material including substantially continuous, ceramic oxide fibers such that the latter (i.e., the metal matrix composite version of the article) has certain desired properties (e.g., Young's modulus, yield strength, and ductility) at least equal to that required for the use of the original article made from the first metal. Optionally, the article may be redesigned to have the same physical dimensions as the original article.

The desired metal matrix composite article configuration, desired properties, possible metals and ceramic oxide material from which it may be desirable for it to be made of, as well as relevant properties of those materials are collected and used to provide possible suitable constructions. A preferred method for generating possible constructions is the use of finite element analysis (FEA), including the use of FEA software run with the aid of a conventional computer system (including the use of a central processing unit (CPU) and input and output devices). Suitable FEA software is commercially available, including that marketed by Ansys, Inc., Canonsburg, Pa. under the trade designation “ANSYS”. FEA assists in modeling the article mathematically and identifying regions where placement of the continuous ceramic oxide fibers and possibly other ceramic oxide materials would provide the desired property levels. For a non-linear geometry, it is typically necessary to run several iterations of FEA to obtain a more preferred design.

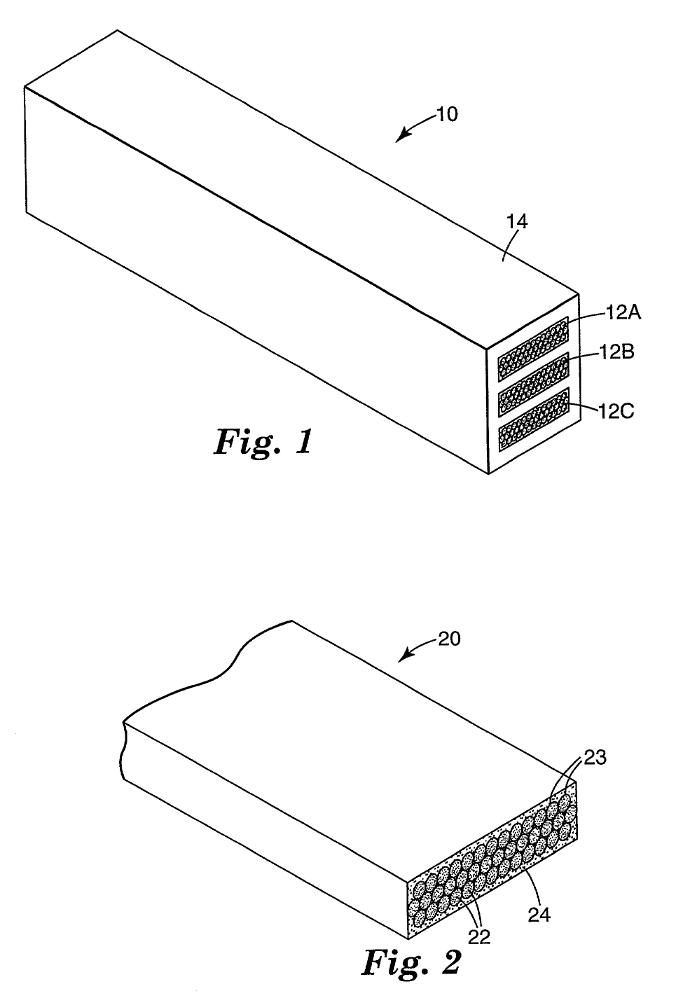

Referring to FIG. 1, ceramic oxide pre-form 10 comprises substantially continuous, longitudinally aligned, ceramic oxide fibers 12 and porous ceramic oxide material 14. Certain preferred porous ceramic oxide material (including porous, sintered ceramic oxide material) comprises alpha alumina.

The continuous reinforcing fibers of the present invention are substantially longitudinally aligned such that they are generally parallel to each other. While these fibers may be incorporated into the ceramic oxide pre-forms as individual fibers, they are more typically incorporated into the pre-form as a group of fibers in the form of a bundle or tow. Fibers within the bundle or tow are maintained in a longitudinally aligned (i.e. generally parallel) relationship with one another. When multiple bundles or tows are utilized in the pre-form, the fiber bundles or tows are also maintained in a longitudinally aligned (i.e. generally parallel) relationship with one another. Typically, it is preferred that all of the continuous reinforcing fibers are maintained in an essentially longitudinally aligned configuration where individual fiber alignment is maintained within ±10°, more preferably ±5°, most preferably ±3°, of their average longitudinal axis. Continuous reinforcing fibers in the form of woven, knitted, and the like fiber constructions typically are not capable of achieving the higher fiber packing densities realized with longitudinally aligned fibers. Thus, metal infiltrated articles based on pre-forms utilizing woven, knitted, or the like fiber constructions typically exhibit lower strength properties than metal infiltrated articles having longitudinally aligned continuous reinforcing fibers and hence are less preferred.

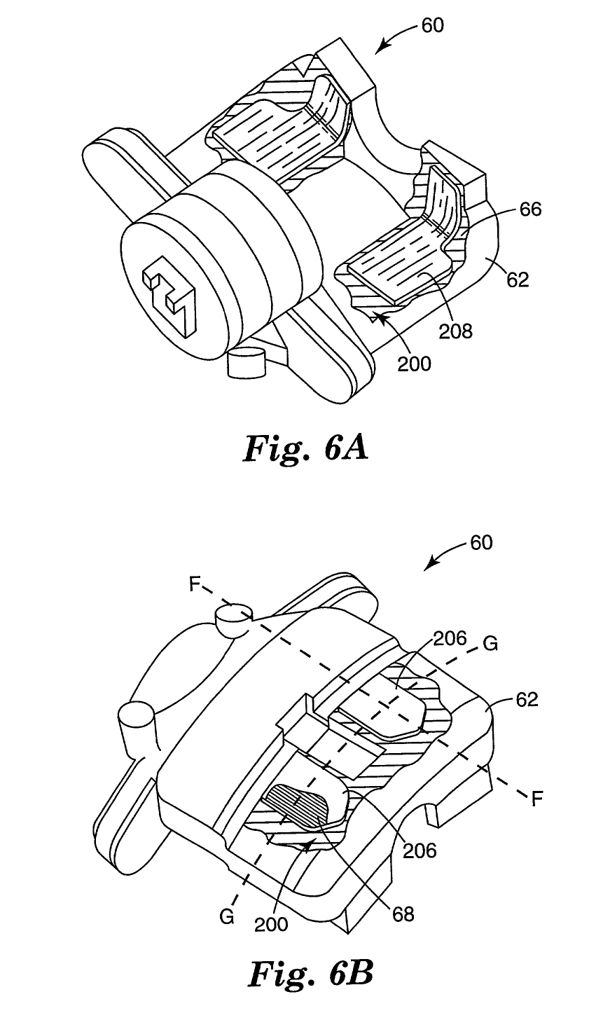

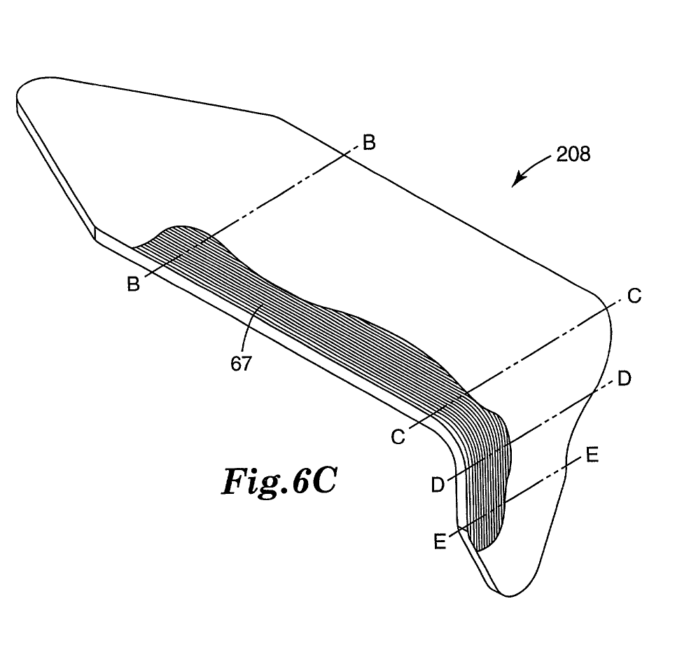

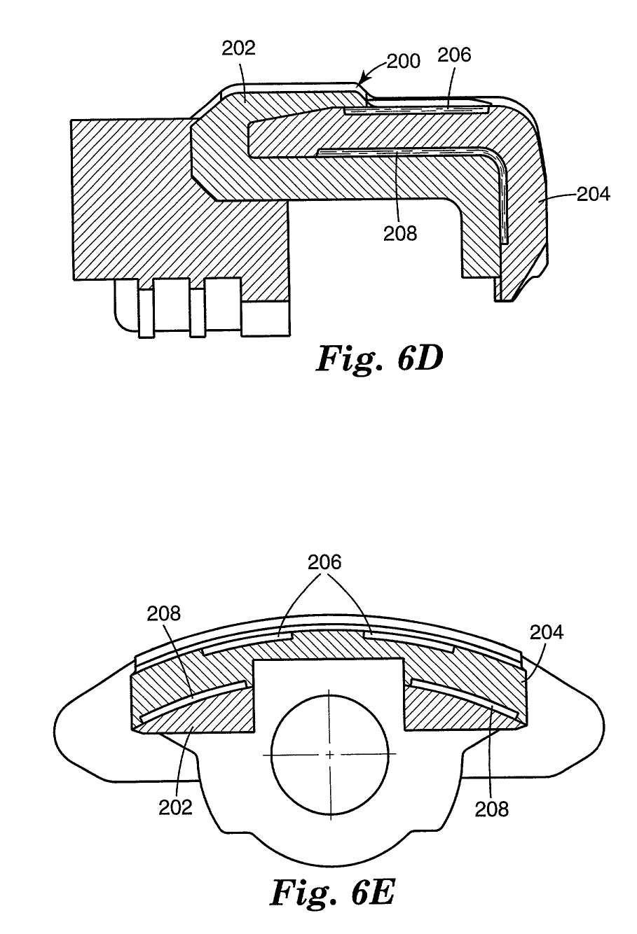

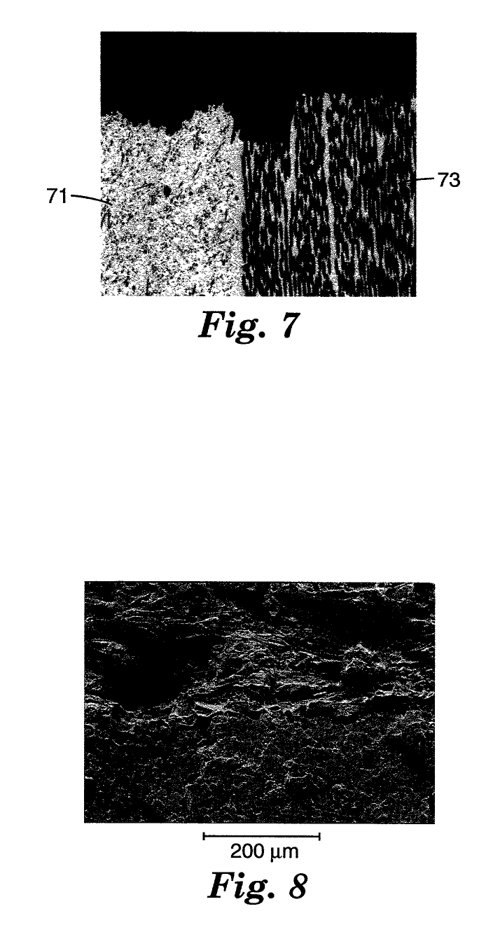

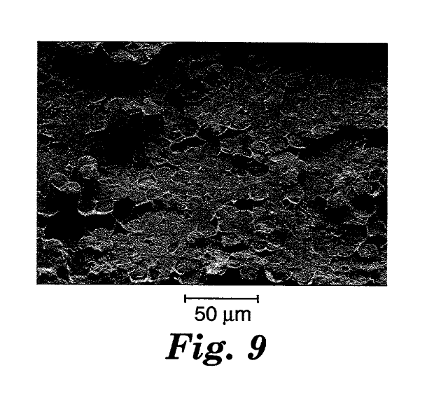

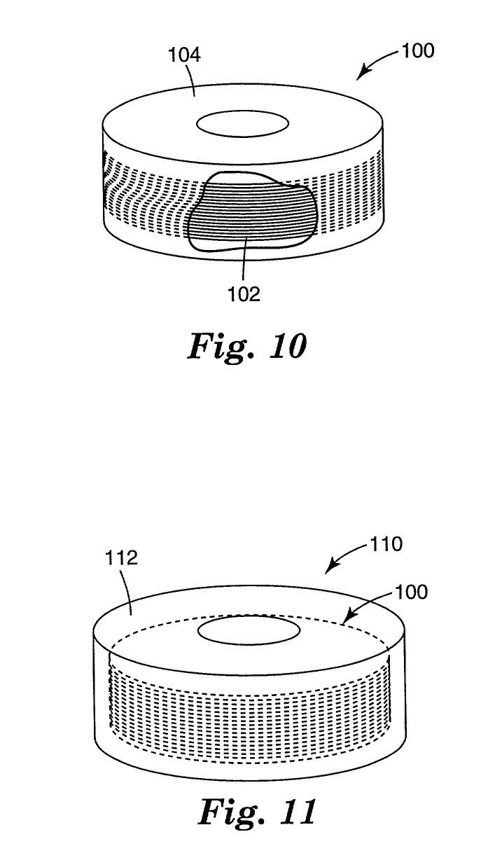

For some pre-form constructions, it may be desirable or necessary for the longitudinally aligned, ceramic oxide fibers to be curved, as opposed to straight (i.e., do not extend in a planar manner). Hence, for example, the longitudinally aligned, ceramic oxide fibers may be planar throughout the fiber length, non-planar (i.e., curved) throughout the fiber length, or they may be planar at some portions and non-planar (i.e., curved) at other portions, wherein the continuous reinforcing fibers are maintained in a substantially non-intersecting, curvilinear arrangement (i.e. longitudinally aligned) throughout the curved portion of the pre-form. In preferred embodiments, the fibers are maintained in a substantially equidistant relationship with each other throughout the curved portion of the pre-form. For example, FIG. 6C, which is a perspective schematic of the substantially continuous alpha alumina fiber insert 208 of FIGS. 6A and 6D, illustrates longitudinally aligned, alpha alumina fibers 67. Longitudinally aligned, alpha alumina fibers 67 are planar between section lines BB and CC and between section lines DD and EE, and curved between section lines CC and DD. Alternatively, the longitudinally aligned, ceramic oxide fibers may be non-planar throughout their lengths. For example, referring to FIG. 10, ceramic oxide pre-form 100 comprises longitudinally aligned, ceramic oxide fibers 102 and porous ceramic oxide material 104, wherein longitudinally aligned, ceramic oxide fibers 102 are curved throughout their lengths. An example of a metal matrix composite article which can be made from the latter type of pre-form is an aluminum metal matrix composite ring, such as shown in FIG. 11. Ring 110 is comprised of metal 112 and ceramic oxide pre-form 100 (see FIG. 10). Such rings are useful, for example, in high speed rotating machinery where they are subject to large centrifugal forces.

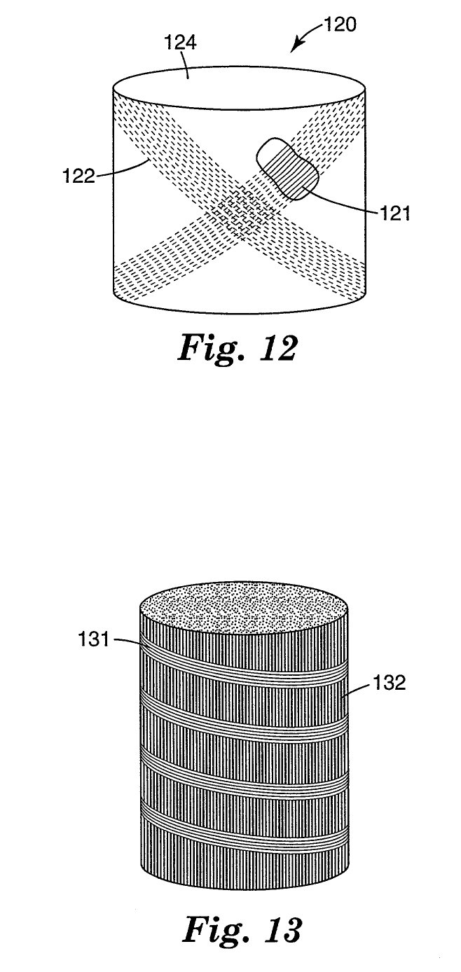

In another aspect, for some pre-form constructions it may be desirable, or required, to have two, three, four, or more plies of the longitudinally aligned, ceramic oxide fibers (i.e., a ply is at least one layer of substantially continuous, longitudinally aligned, ceramic oxide fibers (preferably, at least one layer of tows comprised of substantially continuous, longitudinally aligned, ceramic oxide fibers)). The plies may be oriented with respect to each other any of a variety of ways. Examples of the relationships of the plies to each other are shown in FIGS. 12 and 13. Referring to FIG. 12, ceramic oxide pre-form 120 comprises first and second plies of longitudinally aligned, ceramic oxide fibers 121 and 122 secured in porous ceramic oxide material 124, wherein first ply of longitudinally aligned, ceramic oxide fibers 121 is positioned 45° with respect to second ply of longitudinally aligned, ceramic oxide fibers 122, although depending on the particular application, the difference in position of a ply with respect to another ply(s) may be anywhere between greater than zero degrees to 90°. Preferred positioning of a ply with respect to another ply(s) for some applications may be in the range from about 30° to about 60°, or even, for example, in the range from about 40° to about 50° C. Optionally, porous ceramic oxide material can be between two or more plies.

A grouping of fibers may also benefit from being wrapped with fibers such as shown in FIG. 13, wherein ceramic oxide fibers 131 are spirally wrapped around longitudinally aligned, ceramic oxide fibers 132. An example of a metal matrix composite article which may benefit from the properties offered by plies of longitudinally aligned, ceramic oxide fibers include is an article that under use is subjected to bending forces about two perpendicular axes.

Substantially continuous reinforcing fibers used to make a porous ceramic oxide pre-form preferably have an average diameter of at least about 5 micrometers. Preferably, the average fiber diameter is no greater than about 250 micrometers, more preferably, no greater than about 100 micrometers. For tows of fibers, the average fiber diameter is preferably, no greater than about 50 micrometers, more preferably, no greater than about 25 micrometers.

Preferably, fibers have a Young's modulus of greater than about 70 GPa, more preferably, at least 100 GPa, at least 150 GPa, at least 200 GPa, at least 250 GPa, at least 300 GPa, or even at least 350 GPa.

Examples of substantially continuous fibers that may be useful for making metal matrix composite materials according to the present invention include alpha alumina fibers, such as alpha alumina fibers aluminosilicate fibers, and aluminoborosilicate fibers. Preferably, the ceramic oxide fibers have an average tensile strength of at least about 1.4 GPa, more preferably, at least about 1.7 GPa, even more preferably, at least about 2.1 GPa, and most preferably, at least about 2.8 GPa.

Ceramic oxide fibers are available commercially as single filaments, or grouped together (e.g., as yams or tows). Yarns or tows preferably comprise at least 750 individual fibers per tow, and more preferably at least 2550 individual fibers per tow. Tows are well known in the fiber art and refer to a plurality of (individual) fibers (typically at least 100 fibers, more typically at least 400 fibers) collected in a rope-like form. Ceramic oxide fibers, including tows of ceramic oxide fibers, are available in a variety of lengths. The fibers may have a cross-sectional shape that is circular or elliptical.

Methods for making alumina fibers are known in the art and include the method disclosed in U.S. Pat. No. 4,954,462 (Wood et al.), the disclosure of which is incorporated herein by reference. Preferably, the alumina fibers are polycrystalline alpha alumina-based fibers and comprise, on a theoretical oxide basis, greater than about 99 percent by weight Al₂O₃ and about 0.2-0.5 percent by weight SiO₂, based on the total weight of the alumina fibers. In another aspect, preferred polycrystalline, alpha alumina-based fibers comprise alpha alumina having an average grain size of less than 1 micrometer (more preferably, less than 0.5 micrometer). In another aspect, preferred polycrystalline, alpha alumina-based fibers have an average tensile strength of at least 1.6 GPa (preferably, at least 2.1 GPa, more preferably, at least 2.8 GPa). Preferred alpha alumina fibers are commercially available under the trade designation “NEXTEL 610” from the 3M Company. Another alpha alumina fiber, which comprises about 89 percent by weight Al₂O₃, amount 10 percent by weight ZrO₂, and about 1 percent by weight Y₂O₃, based on the total weight of the fibers, commercially available from the 3M Company is that marketed under the trade designation “NEXTEL 650”.

Suitable aluminosilicate fibers are described in U.S. Pat. No. 4,047,965 (Karst et al.), the disclosure of which is incorporated herein by reference. Preferably, the aluminosilicate fibers comprise, on a theoretical oxide basis, in the range from about 67 to about 85 percent by weight Al₂O₃ and in the range from about 33 to about 15 percent by weight SiO₂, based on the total weight of the aluminosilicate fibers. Some preferred aluminosilicate fibers comprise, on a theoretical oxide basis, in the range from about 67 to about 77 percent by weight Al₂O₃ and in the range from about 33 to about 23 percent by weight SiO₂, based on the total weight of the alumninosilicate fibers. One preferred aluminosilicate fiber comprises, on a theoretical oxide basis, about 85 percent by weight Al₂O₃ and about 15 percent by weight SiO₂, based on the total weight of the aluminosilicate fibers. Another preferred aluminosilicate fiber comprises, on a theoretical oxide basis, about 73 percent by weight Al₂O₃ and about 27 percent by weight SiO₂, based on the total weight of the aluminosilicate fibers. Preferred aluminosilicate fibers are commercially available under the trade designations “NEXTEL 720” and “NEXTEL 550” from the 3M Company.

Suitable aluminoborosilicate fibers are described in U.S. Pat. No. 3,795,524 (Sowman), the disclosure of which is incorporated herein by reference. Preferably, the aluminoborosilicate fibers comprise, on a theoretical oxide basis, about 35 percent by weight to about 75 percent by weight (more preferably, about 55 percent by weight to about 75 percent by weight) Al₂O₃; greater than 0 percent by weight (more preferably, at least about 15 percent by weight) and less than about 50 percent by weight (more preferably, less than about 45 percent, and most preferably, less than about 44 percent) SiO₂; and greater than about 5 percent by weight (more preferably, less than about 25 percent by weight, even more preferably, about 1 percent by weight to about 5 percent by weight, and most preferably, about 2 percent by weight to about 20 percent by weight) B₂O₃, based on the total weight of the aluminoborosilicate fibers. Preferred aluminoborosilicate fibers are commercially available under the trade designations “NEXTEL 312” and “NEXTEL 440” from the 3M Company.

Commercially available substantially continuous ceramic oxide fibers typically include an organic sizing material added to the fiber during their manufacture to provide lubricity and to protect the fiber strands during handling. It is believed that the sizing tends to reduce the breakage of fibers, reduces static electricity, and reduces the amount of dust during, for example, conversion to a fabric. The sizing can be removed, for example, by dissolving or burning it away.

It is also within the scope of the present invention to have coatings on the ceramic oxide fibers. Coatings may be used, for example, to enhance the wettability of the fibers, to reduce or prevent reaction between the fibers and molten metal matrix material. Such coatings and techniques for providing such coatings are known in the fiber and metal matrix composite art.

Porous ceramic oxide pre-form can be made, for example, by casting a slurry of discontinuous ceramic oxide fibers (including whiskers) around the continuous fibers. Typically, the continuous fibers are positioned in a cavity (e.g., mold), and the slurry added to the mold. The continuous fibers are positioned within the cavity such that they will be properly positioned in the resulting ceramic oxide material. The cavity is configured to provide the desired shape, although it is also within the scope of the present invention to reshape the resulting ceramic oxide material, for example, by machining, to provide the desired configuration of the ceramic oxide pre-form.

Suitable discontinuous ceramic oxide fibers (including whiskers) include those made of alumina, including alpha alumina and transitional aluminas (such as delta alumina), aluminosilicate fibers, and aluminoborosilicate fibers, and methods of making and/or sources of such materials, are known in the art. Discontinuous fibers can be made, for example, by cutting or chopping continuous fibers (including the continuous fibers discussed above). Examples of commercially available discontinuous ceramic oxide fibers include those marketed under the trade designation “SAFFIL” from J&J Dyson, Widness, UK, “KAOWOOL” from Thermal Ceramics Inc., Augusta, Ga., and “FIBERFRAX” from Unifrax, Niagara Falls, N.Y.

Typically, the discontinuous fibers have a diameter in the range from about 1 micrometer to about 20 micrometers, preferably, from about 3 micrometers to about 12 micrometers, and are up to about 2.5 cm long, preferably, less than 1.2 cm long, although whiskers typically have a length in the range from about 6 micrometers to about 12 micrometers long.

Optionally, the slurry may further comprise ceramic oxide particles such as alumina (including alpha alumina) particles, aluminosilicate particles, and aluminoborosilicate particles. Typically, the preferred average particle size of the particles is in the range from about 0.05 micrometer to about 50 micrometers. The slurry may further comprise ceramic oxide bonding materials such as colloidal silica, colloidal alumina, and the like which can aid in enhancing the integrity (e.g., by reaction with other components used to make the porous ceramic oxide pre-form to make other phases (e.g., the silica may react with alumina to form mullite)).

A suitable slurry can be formed using techniques known in the art. Typically, slurries are formed by dispersing discontinuous fibers in a liquid medium such as water. To aid in the handling and positioning of the continuous fibers, a fiber insert (e.g., ribbon) can be used. A fiber insert comprises a plurality of the continuous fibers held together with a binder material. Referring to FIG. 2, fiber insert 20 comprises substantially continuous, longitudinally aligned, ceramic oxide fibers 22 and fugitive binder material 24, which serves to secure fibers 22 (as shown in tows 23) into fiber insert 20. Binder material 24 contacts the fibers only to the extent necessary to form fiber insert 20, and may not necessarily be in contact with all fibers. For example, internal fibers may not be in contact with the binder material.

In selecting the binder material for making a fiber insert, consideration is given to adverse effects, if any, the binder material may have on the properties of the ceramic oxide pre-form, as well as the impact, if any, the binder material may have on the use of the ceramic oxide pre-form (e.g., consideration is given to adverse effects, if any, the binder material may have on the properties of a metal matrix composite article made from the ceramic oxide pre-form).

The binder material is used to temporarily bond the continuous fibers together, as well as aid in handling and ultimately placing the fibers in the ceramic oxide pre-form. The binder material may preferably be a fugitive material, which preferably burns out at relatively low temperature during the calcining stage of the pre-form fabrication process leaving no residue or ash. One preferred fugitive binder material is wax (e.g., paraffin), which can be heated above its melting point, applied to the fibers, and then solidified to hold the fibers as desired. Other preferred fugitive binder materials include water soluble polymers such as polyvinyl alcohol (PVA), polyvinyl pyrrolidone (PVP), and combinations thereof. Other suitable fugitive binder materials may include epoxies such as that marketed by Cytec Industries, West Patterson, N.J. (formerly marketed by the 3M Company under the trade designation “SP381 SCOTCHPLY ADHESIVE”).

As discussed above, the ceramic oxide pre-form is typically designed for a certain purpose, and as a result, is desired to have certain properties, have a certain configuration, and be made of certain materials. Typically, the mold is selected or made to provide the desired shape of the article to be cast to form a near net shape. Forming a net-shaped, or near net-shaped article, can, for example, minimize or eliminate the need for and cost of subsequent machining or other post-casting processing of the cast article. The cavity is selected or made to have a desired shape for the resulting ceramic oxide material. Typically, the cavity is made or adapted to hold the continuous fibers in a desired location such that the continuous fibers are properly positioned in the resulting ceramic oxide pre-form. Techniques for making suitable cavities are known to those skilled in the art. Such cavities may be made of rigid material such as of wood, plastic, graphite, and steel (e.g., stainless steel). To facilitate the removal of liquid from the slurry, one or more apertures can be provided in the mold.

A green ceramic oxide pre-form can be made, for example, by positioning the continuous fiber in a cavity, introducing a slurry comprising discontinuous ceramic oxide fibers into the cavity, and removing liquid from slurry. Typically, the liquid is removed via apertures in the cavity. Removal of the liquid through the apertures can be enhanced with the aid of a vacuum. Preferably, the vacuum is less than 1000 mbars, more preferably, less than 850 mbars. Alternatively, or in addition to the vacuum, removal of liquid from the cavity can be enhanced by the application of pressure.

Unless the green pre-form is dried in the cavity, it is typically dried after removal from the cavity before calcining or sintering. Preferably, pre-form is dried to at least one temperature in the range from about 70° C. to about 100° C., more preferably, from about 85° C. to about 100° C., and typically most preferably, at about 100° C.

The green pre-form is typically calcined prior to sintering. Calcining is heating a material to a temperature(s) to eliminate free water, and preferably at least about 90 wt-% of any bound volatiles constituents, but without fusion, as opposed to sintering wherein material is heated to a temperature(s) bonding of by solid-state reactions at temperatures lower than those required for the formation of a liquid phase.

Typical calcining temperatures are in the range from 400° C. to about 800° C., preferably from about 600° C. to about 800° C. Typical sintering temperatures are in the range from 900° C. to about 1150° C., preferably from about 950° C. to about 1100° C., more preferably from about 950° C. to about 1100° C.

The drying, calcining, and sintering times may depend, for example, on the materials involved, as well as the configuration (including size) of the pre-form.

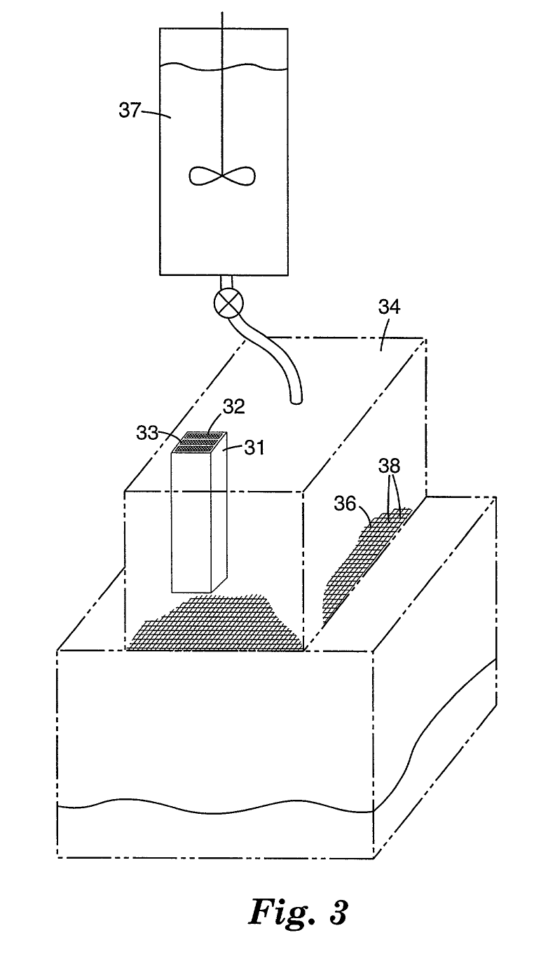

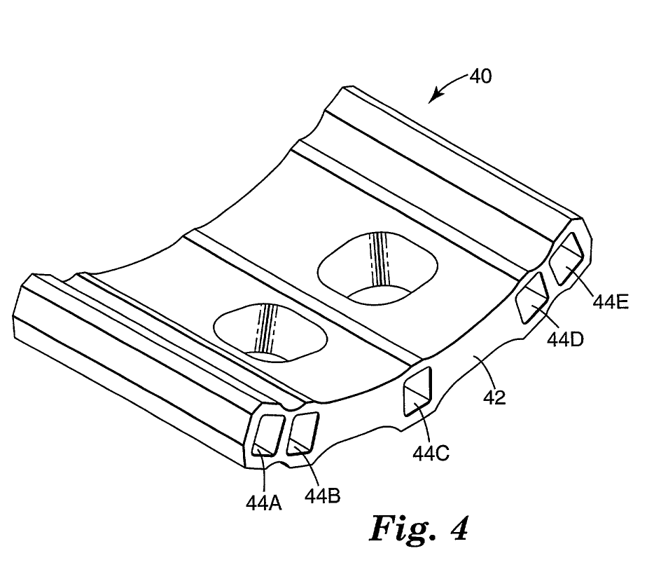

The orientation of the discontinuous fibers with respect to the length of the continuous fibers may be adjusted by the fabrication process used to make the ceramic oxide pre-form. For example, the positioning apertures in the bottom of the cavity used to hold the slurry to preferentially remove the liquid from the bottom (or top) of the cavity (as opposed to the sides) may result in the largest dimension of the discontinuous fibers preferentially being more parallel to the length of continuous fibers positioned parallel to the lengths of the sides of the cavity than perpendicular. For example, referring to FIG. 3, fiber insert or ribbon 31, which comprises plurality of the continuous fibers 32 held together with binder material 33, is positioned in cavity 34. The length of continuous fibers 32 is parallel to sides of cavity 34, and perpendicular to bottom 36 of cavity 34. Liquid from slurry 37 is removed from via apertures 38, such that the largest dimension of discontinuous fibers preferentially being more perpendicular to the length of continuous fibers 32 than parallel.

Preferably, removal of the liquid is aided by a vacuum. For example, a fiber insert may be affixed in the mold such that it held in the desired location by clips at each end of the fiber insert. In one vacuum forming technique, a screen is placed on one side of the mold for water removal under vacuum. The placement of the screen is determined by the desired orientation of the discontinuous fibers. For example, if it is desired to preferentially align discontinuous fibers to be perpendicular to the fiber the lengths of continuous, longitudinally aligned fibers, the screen can be positioned at one of the ends of the fiber lengths, perpendicular to the length of the fibers. The slurry can be added, for example, by submersing the mold in the slurry, then removing or pumping the slurry from the mold. A vacuum can be applied to the screen side of the mold to draw out the liquid. When the liquid is removed, the discontinuous fibers are preferentially aligned with respect to the lengths of the continuous fibers. Subsequent pressure may be applied to the fibers to force out more water, and may also aid in densifying the discontinuous fiber.

Similarly, for example, positioning apertures or holes in the sides of the cavity used to hold the slurry to preferentially remove the liquid from the sides of the cavity (as opposed to the top an bottom) may result in the largest dimension of the discontinuous fibers preferentially being more perpendicular to the length of continuous fibers positioned parallel to the lengths of the sides of the cavity than parallel.

Ceramic oxide pre-form may comprise more than one grouping (e.g., two groupings, three groupings, etc.) of substantially continuous, longitudinally aligned, ceramic oxide fibers, wherein a grouping of substantially continuous, longitudinally aligned, ceramic oxide fibers is spaced apart from another grouping(s) with the porous ceramic oxide material there between. For example, referring again to FIG. 1 ceramic oxide pre-form 10 comprises groupings 12A, 12B, and 12C of substantially continuous, longitudinally aligned, ceramic oxide fibers 12 and porous ceramic oxide material 14.

The ceramic oxide pre-form may be in any of a variety of shapes, including a rod (including a rod having a circular, rectangular, or square cross-section), an I-beam, or a tube. The ceramic oxide pre-form may be elongated and have a substantially constant cross-sectional area.

For some applications, a porous ceramic oxide pre-form comprising substantially continuous, longitudinally aligned, ceramic oxide fibers and porous ceramic oxide material, such as ceramic oxide pre-form 10 in FIG. 1, can be used as an insert or as a pre-form for reinforcing a metal matrix composite article. For some uses of the ceramic oxide pre-form, it may be desirable to prepare a second ceramic oxide pre-form having at least one aperture to receive one or more ceramic oxide pre-forms according to the present invention. For example, referring to FIG. 4, ceramic oxide pre-form 40 is comprised of porous ceramic oxide material 42 and has apertures 44A, 44B, 44C, 44D, and 44E, for receiving ceramic oxide pre-form according to the present invention. As shown, apertures 44A, 44B, 44C, 44D, and 44E are designed to each receive a porous ceramic oxide pre-form 10 (see FIG. 1). The second ceramic oxide pre-form can be made as described above, as well as by techniques known in the art. In one preferred embodiment, the Young's modulus of the first porous material is greater than the Young's modulus of the second porous material, and the Young's modulus of the continuous fibers is greater than the Young's modulus of the first porous material.

It is also within the scope of the present invention to form the ceramic oxide material which secures the continuous fibers, including providing aperture(s) therein for the continuous fibers, then inserting the fibers into the aperture(s).

For additional details regarding the formation of ceramic oxide pre-forms, see, for example, U.S. Pat. No. 5,394,930 (Kennerknecht) and Great Britain Pat. Doc. Nos. 2,182,970 A and B, published May 28, 1987 and Sep. 14, 1988, respectively, the disclosures of which are incorporated herein by reference. Other techniques and other preferred conditions may be apparent those skilled in the art after reviewing the disclosure herein.

An example of a metal matrix composite article according to the present invention made from a porous ceramic oxide pre-form shown in FIGS. 6A, 6B, 6C, and 6D. Brake caliper 60 for a motor vehicle (e.g., a car, sports utility vehicle, van, or truck, is comprised of metal (e.g., aluminum) 62 and ceramic oxide pre-form according to the present invention 200. FIGS. 6D and 6E are cross-sectional views of FIG. 6B along lines FF and GG, respectively. In FIG. 6D and 6E, ceramic oxide pre-form 200 comprises porous ceramic oxide material 202 and 204 and substantially continuous, longitudinally aligned, ceramic oxide fiber inserts 206 and 208 which include substantially continuous, longitudinally aligned, ceramic oxide fibers, 68 and 67, respectively.

The open porosity of the porous ceramic oxide material can be determined as follows. The test is based on ASTM C20-97, published August, 1998, the disclosure of which is incorporated herein. Five pieces of the sample to be tested are cleaned by removing any dust with an air hose. The samples are dried in an oven at 110° C. (230° F.) for about 18 hours and weighed. The samples are then boiled in deionized water for 3 hours, allowed to cool in the water to room temperature (about 25° C.), then kept in water for about 18 hours in the water. The samples are weighed suspended in water. The samples are removed from the water, excess water blotted off with a paper towel, and the weight of the water saturated sample determined. The samples are again dried in an oven at 110° C. (230° F.) for about 18 hours and weighed. The open porosity, which is the volume. of pores, is determined by subtracting the dry weigh of the sample from the weight of the water saturated sample, and dividing the result by the density of water (i.e., 1 gram/cm³).

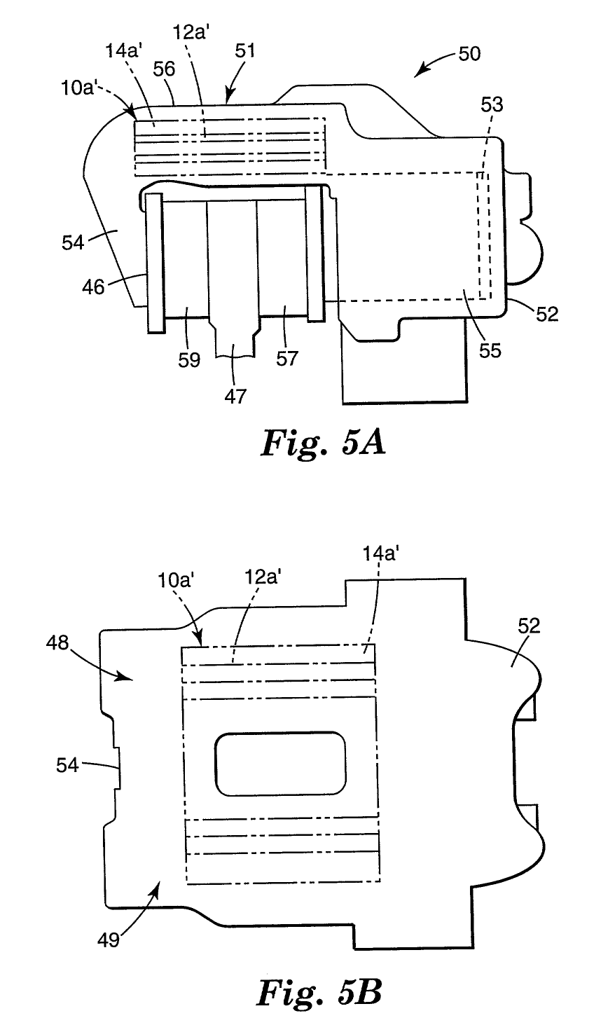

Another exemplary construction of a brake caliper incorporating a porous ceramic oxide pre-form, as well as a brake system for a motor vehicle (e.g., a car, sports utility vehicle, van, or truck utilizing the brake caliper, is shown in FIG. 5. An example of a disc brake for a motor vehicle comprises a rotor; inner and outer brake pads disposed on opposite sides of the rotor and movable into braking engagement therewith; a piston for urging the inner brake pad against the rotor; and the brake caliper comprising a body member having a cylinder positioned on one side of the rotor and containing the piston, an arm member positioned on the other side of the rotor and supporting the outer brake pad, and a bridge extending between the body member and the arm member across the plane of the rotor.

Referring again to FIG. 5, disc brake assembly 50 comprises brake caliper housing 51 formed of body member 52, arm member 54, and bridge 56 connected at one end to body member 52 and at other end to arm member 54. Body member 52 has a generally cylindrical recess 53 therein which slideably receives piston 55 to which is pressed inner brake pad 57. Inner face 46 of arm member 54 supports outer brake pad 59 which faces inner brake pad 57. Brake rotor 47, connected to a wheel (not shown) of a vehicle, lies between inner and outer brake pads 57, 59, respectively. Ceramic oxide pre-form 10a′, comprising continuous alpha alumina oxide fibers 12a′and porous ceramic oxide material 14a′, is located in bridge 56.

Hydraulic, or other, actuation of piston 55 causes inner brake pad 57 to be urged against one side of rotor 47 and, by reactive force, causes caliper housing 51 to float, thereby bringing outer brake pad 59 into engagement with the other side of rotor 47, as is well known in the art.

Examples of disc brakes for using metal matrix composite brake calipers incorporating ceramic oxide pre-forms according to the present invention include fixed, floating and sliding types. Additionally details regarding brake calipers and brake systems can be found, for example, in U.S. Pat. Nos. 4,705,093 (Ogino) and 5,234,080 (Pantale), the disclosures of which are incorporated herein by reference.

Other examples of metal matrix composite articles which can be made from ceramic oxide pre-forms include automotive components (e.g., automotive control arms and automotive wrist pins) and gun components (such as barrel support for rifled steel liner).

Typically, metal matrix composite articles made from ceramic oxide pre-forms comprise, in the region comprising the continuous ceramic fibers, in the range from about 30 to about 45 percent (preferably about 35 to about 45 percent, more preferably, about 35 to about 40 percent) by volume metal and in the range from about 70 to about 55 percent (preferably about 65 to about 55 percent, more preferably, about 60 to about 65 percent) by volume continuous ceramic fibers, based on the total volume of the region. Further, the region comprising the porous ceramic oxide material which secures the continuous ceramic fibers, typically comprises in the range from about 20 to about 95 percent (preferably about 60 to about 90 percent, more preferably, about 80 to about 85 percent) by volume metal and in the range from about 80 to about 5 percent (preferably about 60 to about 10 percent, more preferably, about 15 to about 5 percent) by volume porous ceramic oxide material, based on the total volume of the region.

The fiber and metal volume content of the metal matrix composite in the continuous fiber region is generally governed by the desired to produce a homogeneous composite without significant movement of the continuous fibers during the metal infiltration. If the fiber content is too low, it is more difficult to prevent or minimize movement of the continuous fibers during the metal infiltration. In the discontinuous fiber region the fiber and metal volume content of the composite is, in general, governed by balance between increased strength and stiffness versus decreased ductility and machinability. The metal comprising the metal matrix composite is preferably selected such that the matrix material does not significantly react chemically with the ceramic oxide material, (i.e., is relatively chemically inert with respect to the-metallic, refractory material), particularly the continuous fibers, for example, to eliminate the need to provide a protective coating on the fiber exterior. Preferred metal matrix materials include aluminum, zinc, tin, and alloys thereof (e.g., an alloy of aluminum and copper). More preferably, the matrix material includes aluminum and alloys thereof. For aluminum matrix materials, the matrix preferably comprises at least 98 percent by weight aluminum, more preferably, at least 99 percent by weight aluminum, even more preferably, greater than 99.9 percent by weight aluminum, and most preferably, greater than 99.95 percent by weight aluminum. Preferred aluminum alloys include aluminum and copper such as an alloy comprising at least about 98 percent by weight Al and up to about 2 percent by weight Cu. Although higher purity metals tend to be preferred for making higher tensile strength materials, less pure forms of metals are also useful.

Suitable metals are commercially available. For example, aluminum is available under the trade designation “SUPER PURE ALUMINUM; 99.99% Al” from Alcoa of Pittsburgh, Pa. Aluminum alloys (e.g., Al-2 percent by weight Cu (0.03 percent by weight impurities) can be obtained from Belmont Metals, New York, N.Y. Other useful aluminum alloys include those commonly designated “295,” “319,” “354,” “355,” “356,” “357,” “380,” “295,” “713,” and “6061”. Zinc and tin are available, for example, from Metal Services, St. Paul, Minn. (“pure zinc”; 99.999% purity and “pure tin”; 99.95% purity). Examples of tin alloys include 92 wt.% Sn-8 wt.% Al (which can be made, for example, by adding the aluminum to a bath of molten tin at 550° C. and permitting the mixture to stand for 12 hours prior to use). Examples of tin alloys include 90.4 wt.% Zn-9.6 wt.% Al (which can be made, for example, by adding the aluminum to a bath of molten zinc at 550° C. and permitting the mixture to stand for 12 hours prior to use).

The particular fibers, matrix material, and process steps for making metal matrix composite articles are selected to provide metal matrix composite article with the desired properties. For example, the fibers and metal matrix materials are selected to be sufficiently compatible with each other and the article fabrication process in order to make the desired article. Additional details regarding some preferred techniques for making aluminum and aluminum alloy matrix composites are disclosed, for example, in co-pending applications having U.S. Serial Nos. 08/492,960, filed Jun. 21, 1995 and 09/616,589, 09/616,593, and 09/616,594, filed Jul. 14, 2000, and PCT application having publication No. WO 97/00976, published Jan. 9, 1997, the disclosures of which are incorporated herein by reference.

Fabrication of metal matrix composites using ceramic oxide pre-forms can be conducted using techniques known in the art. Such fabrication includes infiltrating the porous pre-form with molten metal. Typically, it is preferably for the ceramic oxide pre-form(s) to be at an elevated temperature (e.g., 750-800° C.) when the molten metal is contacted with it. Such techniques are known in the art and include heating the pre-form before it is positioned in the cavity or mold that forms the metal, or heating the cavity or mold after the ceramic oxide pre-form has been positioned therein.

Additional details regarding making metal matrix composites from ceramic oxide pre-forms can be found, for example, in U.S. Pat. Nos. 4,705,093 (Ogino) and 5,234,080 (Pantale), and 5,394,093 (Kennerknecht), the disclosures of which are incorporated herein by reference.

Further, for additional details regarding the formation of ceramic oxide pre-forms, and metal matrix composite article made from ceramic oxide pre-forms see, for example, provisional applications having U.S. Ser. Nos. 60/236,091 and 60/236,092 filed Sep. 28, 2000, and applications having U.S. Ser. Nos. ______ and ______ filed the same date as the instant application (Attorney Docket Nos. 55954US002 and 55955US002), the disclosures of which are incorporated herein by reference.

Various modifications and alterations of this invention will become apparent to those skilled in the art without departing from the scope and spirit of this invention, and it should be understood that this invention is not to be unduly limited to the illustrative embodiments set forth herein.

What is claimed is:

1. A method for making a porous ceramic oxide pre-form for an article comprising metal matrix material, the method comprising:
designing an article to comprise metal matrix composite material reinforced, at least in part, with at least two plies comprised of substantially continuous, longitudinally aligned, ceramic oxide fibers having lengths of at least 5 cm, wherein the metal matrix composite material to comprise at least one ceramic oxide pre-form comprising ceramic oxide material extends along at least a portion of the respective lengths of the substantially continuous, longitudinally aligned, ceramic oxide fibers, wherein first and second plies comprised of the substantially continuous, longitudinally aligned, ceramic oxide fibers have lengths that extend in a first and second direction, respectively, and wherein the first and second directions are oriented in the range from greater than 0° to 90° with respect to one another, and wherein the substantially continuous, longitudinally aligned, ceramic oxide fibers have a first Young's modulus and the ceramic oxide material has a second Young's modulus, and wherein the first Young's modulus is greater than the second Young's modulus; and
preparing, based on the resulting design, a porous ceramic oxide pre-form comprising ceramic oxide material securing the plies comprised of the substantially continuous, ceramic oxide fibers in place, wherein the ceramic oxide material extends along at least a portion of the respective lengths of the substantially continuous, longitudinally aligned, ceramic oxide fibers, and wherein the first and second directions are oriented in the range from greater than 0° to 90° with respect to one another.

2. The method according to claim 1 wherein the substantially continuous ceramic oxide fibers have lengths of at least 10 cm.

3. The method according to claim 1 wherein a portion of the ceramic oxide material is between the first and second plies.

4. The method according to claim 1 wherein the substantially continuous ceramic oxide fibers in the first and second two plies are, in a ply, essentially longitudinally aligned.

5. The method according to claim 1 wherein the first and second directions are oriented in the range from 30° to 60° with respect to one another.

6. The method according to claim 1 wherein the first and second directions are oriented in the range from 40° to 50° with respect to one another.

7. The method according to claim 1 further comprising a third ply comprised of substantially continuous, longitudinally aligned, ceramic oxide fibers having lengths of at least 5 cm, wherein the substantially continuous, longitudinally aligned, ceramic oxide fibers of the third ply have lengths that extend in a third direction, and wherein the third direction is oriented in the range from greater than 0° to 90° with respect to at least one of the first or second directions.

8. The method according to claim 1 wherein the porous ceramic oxide material of the second ceramic article is comprised of alpha alumina.

9. The method according to claim 1 wherein at least a portion of the substantially continuous ceramic oxide fibers is in the form of tows.

10. The method according to claim 9 wherein the ceramic oxide material has an open porosity of at least 85% by volume.

11. The method according to claim 9 wherein the first and second directions are oriented in the range from 30° to 60° with respect to one another.

12. The method according to claim 11 wherein the ceramic oxide material has an open porosity of at least 85% by volume.

13. The method according to claim 1 wherein the metal matrix is one of aluminum or an alloy thereof.

14. The method according to claim 9 further comprising a third ply comprised of tows comprised of substantially continuous, longitudinally aligned, ceramic oxide fibers, wherein the tows of the third ply have lengths that extend in a third direction, and wherein the third direction is oriented in the range from greater than 0° to 90° with respect to at least one of the first or second directions.

15. The method according to claim 14 wherein the ceramic oxide material has an open porosity of at least 85% by volume.

16. The method according to claim 9 wherein the porous ceramic oxide material is comprised of alpha alumina.

17. The method according to claim 16 wherein the ceramic oxide material has an open porosity of at least 85% by volume.

18. The method according to claim 9 wherein the metal matrix is one of aluminum or an alloy thereof.

19. The method according to claim 18 wherein the ceramic oxide material has an open porosity of at least 85% by volume.

20. The method of claim 1 wherein the ceramic oxide material has an open porosity of at least 85% by volume.

21. A method for making a porous ceramic oxide pre-form for an article comprising metal matrix material, the method comprising:
designing an article to comprise metal matrix composite material reinforced, at least in part, with at least two plies comprised of substantially continuous, longitudinally aligned, ceramic oxide fibers having lengths of at least 5 cm, wherein first and second plies comprised of the substantially continuous, longitudinally aligned, ceramic oxide fibers have lengths that extend in a first and second direction, respectively, and wherein the first and second directions are oriented in the range from greater than 0° to 90° with respect to one another;
preparing, based on the resulting design, an elongated pre-form comprising the plies comprised of substantially continuous, longitudinally aligned, ceramic oxide fibers and binder material bonding substantially continuous, longitudinally aligned, ceramic oxide fibers together, wherein the first and second directions are oriented in the range from greater than 0° to 90° with respect to one another;
preparing a green ceramic oxide pre-form comprising green ceramic oxide material extending along at least a portion of the length of the elongated pre-form; and
heating the green ceramic oxide pre-form to provide a porous ceramic oxide pre-form comprising ceramic oxide material securing the plies comprised of substantially continuous, longitudinally aligned, ceramic oxide fibers in place, wherein the ceramic oxide material extends along at least a portion of the lengths of the plies, wherein the first and second directions are oriented in the range from greater than 0° to 90° with respect to one another.

22. The method according to claim 21 wherein the substantially continuous ceramic oxide fibers have lengths of at least 10 cm.

23. The method according to claim 21 wherein a portion of the porous ceramic oxide material is between the first and second plies.

24. The method according to claim 21 wherein the substantially continuous ceramic oxide fibers in the first and second two plies are, in a ply, essentially longitudinally aligned.

25. The method according to claim 21 wherein the first and second directions are oriented in the range from 30° to 60° with respect to one another.

26. The method according to claim 21 wherein the first and second directions are oriented in the range from 40° to 50° with respect to one another.

27. The method according to claim 21 further comprising a third ply comprised of substantially continuous, longitudinally aligned, ceramic oxide fibers having lengths of at least 5 cm, wherein the substantially continuous, longitudinally aligned, ceramic oxide fibers of the third ply have lengths that extend in a third direction, and wherein the third direction is oriented in the range from greater than 0° to 90° with respect to at least one of the first or second directions.

28. The method according to claim 21 wherein the porous ceramic oxide material is comprised of alpha alumina.

29. The method according to claim 22 wherein at least a portion of the substantially continuous ceramic oxide fibers is in the form of tows.

30. The method according to claim 29 wherein the ceramic oxide material has an open porosity of at least 85% by volume.

31. The method according to claim 29 further comprising a third ply comprised of tows comprised of substantially continuous, longitudinally aligned, ceramic oxide fibers, wherein the tows of the third ply have lengths that extend in a third direction, and wherein the third direction is oriented in the range from greater than 0° to 90° with respect to at least one of the first or second directions.

32. The method according to claim 29 wherein the porous ceramic oxide material is comprised of alpha alumina.

33. The method according to claim 32 wherein the metal matrix is at least one of aluminum or an alloy thereof.

34. The method according to claim 29 wherein the metal matrix is at least one of aluminum or an alloy thereof.

35. The method according to claim 29 wherein the first and second directions are oriented in the range from 30° to 60° with respect to one another.

36. The method according to claim 35 wherein the ceramic oxide material has an open porosity of at least 85% by volume.

37. The method according to claim 29 further comprising a third ply comprised of tows comprised of substantially continuous, longitudinally aligned, ceramic oxide fibers, wherein the tows of the third ply have lengths that extend in a third direction, and wherein the third direction is oriented in the range from greater than 0° to 90° with respect to at least one of the first or second directions.

38. The method according to claim 37 wherein the ceramic oxide material has an open porosity of at least 85% by volume.

39. The method according to claim 29 wherein the porous ceramic oxide material is comprised of alpha alumina.

40. The method according to claim 39 wherein the ceramic oxide material has an open porosity of at least 85% by volume.

41. The method according to claim 29 wherein the metal matrix is at least one of aluminum or an alloy thereof.

42. The method according to claim 41 wherein the ceramic oxide material has an open porosity of at least 85% by volume.

43. The method according to claim 21 wherein the ceramic oxide material has an open porosity of at least 85% by volume.

44. A metal matrix composite article comprising a porous ceramic oxide and metal matrix material, wherein the ceramic oxide pre-form comprises first and second plies each comprised of substantially continuous ceramic oxide fibers having lengths of at least 5 cm and a porous ceramic oxide material extending along at least a portion of the respective lengths of the substantially continuous, longitudinally aligned, ceramic oxide fibers, wherein the substantially continuous, longitudinally aligned, ceramic oxide fibers in the first and second plies have lengths that extend in a first and second direction, respectively, and wherein the first and second directions are oriented in the range from greater than 0° to 90° with respect to one another and wherein the porous ceramic oxide material is infiltrated with at least a portion of the metal matrix material.

45. The metal matrix composite article according to claim 44 wherein the substantially continuous ceramic oxide fibers have lengths of at least 10 cm.

46. The metal matrix composite article according to claim 44 wherein a portion of the porous ceramic oxide material is between the first and second plies.

47. The metal matrix composite article according to claim 44 wherein the substantially continuous ceramic oxide fibers in the first and second two plies are, in a ply, essentially longitudinally aligned.

48. The metal matrix composite article according to claim 44 wherein the first and second directions are oriented in the range from 30° to 60° with respect to one another.

49. The metal matrix composite article according to claim 44 wherein the first and second directions are oriented in the range from 40° to 50° with respect to one another.

50. The metal matrix composite article according to claim 44 further comprising a third ply comprised of substantially continuous, longitudinally aligned, ceramic oxide fibers having lengths of at least 5 cm, wherein the substantially continuous, longitudinally aligned, ceramic oxide fibers of the third ply have lengths that extend in a third direction, and wherein the third direction is oriented in the range from greater than 0° to 90° with respect to at least one of the first or second directions.

51. The metal matrix composite article according to claim 44 wherein the porous ceramic oxide material is comprised of alpha alumina.

52. The metal matrix composite article according to claim 44 wherein the metal matrix material is aluminum or an alloy thereof.

53. The metal matrix composite article according to claim 44 comprising at least two groupings of the substantially continuous ceramic oxide fibers spaced apart with the porous ceramic oxide material between the groupings of substantially continuous ceramic oxide fibers.

54. The metal matrix composite article according to claim 44 comprising at least two groupings of the substantially continuous ceramic oxide fibers spaced apart with the porous ceramic oxide material between the groupings of substantially continuous ceramic oxide fibers, wherein at least two of the groupings having a rectangular cross-section.

55. The metal matrix composite article according to claim 44 wherein the ceramic oxide pre-form is elongated and has a rectangular cross-section perpendicular to the length of the substantially continuous ceramic oxide fibers.

56. The metal matrix composite article according to claim 44 wherein the ceramic oxide pre-form is elongated and has substantially constant cross-sectional area.

57. The metal matrix composite article according to claim 44 wherein the substantially continuous ceramic oxide fibers are encapsulated within the porous ceramic oxide material.

58. The metal matrix composite article according to claim 44 wherein the metal matrix material is aluminum or an alloy thereof.

59. The metal matrix composite article according to claim 44 wherein the article is a brake caliper.

60. A disc brake for a motor vehicle comprising a rotor; inner and outer brake pads disposed on opposite sides of the rotor and movable into braking engagement therewith; a piston for urging the inner brake pad against the rotor; and the brake caliper according to claim 59 comprising a body member having a cylinder positioned on one side of the rotor and containing the piston, an arm member positioned on the other side of the rotor and supporting the outer brake pad, and a bridge extending between the body member and the arm member across the plane of the rotor.

61. The metal matrix composite article according to claim 44 wherein at least a portion of the substantially continuous ceramic oxide fibers is in the form of tows.

62. The metal matrix composite article according to claim 61 wherein the first and second directions are oriented in the range from 30° to 60° with respect to one another.

63. The metal matrix composite article according to claim 61 further comprising a third ply comprised of substantially continuous, longitudinally aligned, ceramic oxide fibers having lengths of at least 5 cm, wherein the substantially continuous, longitudinally aligned, ceramic oxide fibers of the third ply have lengths that extend in a third direction, and wherein the third direction is oriented in the range from greater than 0° to 90° with respect to at least one of the first or second directions.

64. The metal matrix composite article according to claim 61 wherein the porous ceramic oxide material is comprised of alpha alumina.

65. The metal matrix composite article according to claim 61 wherein the metal matrix material is aluminum or an alloy thereof.

66. The metal matrix composite article according to claim 61 wherein the article is a brake caliper.

67. A disc brake for a motor vehicle comprising a rotor; inner and outer brake pads disposed on opposite sides of the rotor and movable into braking engagement therewith; a piston for urging the inner brake pad against the rotor; and the brake caliper according to claim 66 comprising a body member having a cylinder positioned on one side of the rotor and containing the piston, an arm member positioned on the other side of the rotor and supporting the outer brake pad, and a bridge extending between the body member and the arm member across the plane of the rotor.

68. The metal matrix composite article according to claim 44 wherein the porous ceramic oxide material has an open porosity of at least 85% by volume.

69. The metal matrix composite article according to claim 68 wherein the first and second directions are oriented in the range from 30° to 60° with respect to one another.

70. The metal matrix composite article according to claim 68 further comprising a third ply comprised of substantially continuous, longitudinally aligned, ceramic oxide fibers having lengths of at least 5 cm, wherein the substantially continuous, longitudinally aligned, ceramic oxide fibers of the third ply have lengths that extend in a third direction, and wherein the third direction is oriented in the range from greater than 0° to 90° with respect to at least one of the first or second directions.

71. The metal matrix composite article according to claim 68 wherein the porous ceramic oxide material is comprised of alpha alumina.

72. The metal matrix composite article according to claim 68 wherein the metal matrix material is aluminum or an alloy thereof.

73. The metal matrix composite article according to claim 68 wherein the article is a brake caliper.

74. A disc brake for a motor vehicle comprising a rotor; inner and outer brake pads disposed on opposite sides of the rotor and movable into braking engagement therewith; a piston for urging the inner brake pad against the rotor; and the brake caliper according to claim 73 comprising a body member having a cylinder positioned on one side of the rotor and containing the piston, an arm member positioned on the other side of the rotor and supporting the outer brake pad, and a bridge extending between the body member and the arm member across the plane of the rotor.

75. The metal matrix composite article according to claim 68 wherein at least a portion of the substantially continuous ceramic oxide fibers is in the form of tows.

76. The metal matrix composite article according to claim 75 wherein the first and second directions are oriented in the range from 30° to 60° with respect to one another.

77. The metal matrix composite article according to claim 75 further comprising a third ply comprised of substantially continuous, longitudinally aligned, ceramic oxide fibers having lengths of at least 5 cm, wherein the substantially continuous, longitudinally aligned, ceramic oxide fibers of the third ply have lengths that extend in a third direction, and wherein the third direction is oriented in the range from greater than 0° to 90° with respect to at least one of the first or second directions.

78. The metal matrix composite article according to claim 75 wherein the porous ceramic oxide material is comprised of alpha alumina.

79. The metal matrix composite article according to claim 75 wherein the metal matrix material is aluminum or an alloy thereof.

80. The metal matrix composite article according to claim 75 wherein the article is a brake caliper.

81. A disc brake for a motor vehicle comprising a rotor; inner and outer brake pads disposed on opposite sides of the rotor and movable into braking engagement therewith; a piston for urging the inner brake pad against the rotor; and the brake caliper according to claim 80 comprising a body member having a cylinder positioned on one side of the rotor and containing the piston, an arm member positioned on the other side of the rotor and supporting the outer brake pad, and a bridge extending between the body member and the arm member across the plane of the rotor.

82. A metal matrix composite article comprising a porous ceramic oxide and metal matrix material, wherein the ceramic oxide pre-form comprises:
a first porous ceramic article including an aperture for receiving a porous ceramic oxide; and
a second ceramic article positioned in the aperture, the second ceramic article comprising porous ceramic oxide material and first and second plies each comprised of substantially continuous, longitudinally aligned, ceramic oxide fibers having lengths of at least 5 cm, the porous ceramic oxide material securing the substantially continuous ceramic oxide fibers in place, wherein the porous ceramic oxide material extends along at least a portion of the respective lengths of the substantially continuous, longitudinally aligned, ceramic oxide fibers, wherein the substantially continuous, longitudinally aligned, ceramic oxide fibers in the first and second plies have lengths that extend in a first and second direction, respectively, and wherein the first and second directions are oriented in the range from greater than 0° to 90° with respect to one another, and
wherein the porous ceramic oxide material is infiltrated with at least a portion of the metal matrix material.

83. The metal matrix composite article according to claim 82 wherein a portion of the porous ceramic oxide material is between the first and second plies.

84. The metal matrix composite article according to claim 82 wherein the substantially continuous ceramic oxide fibers in the first and second two plies are, in a ply, essentially longitudinally aligned.

85. The metal matrix composite article according to claim 82 wherein the first and second directions are oriented in the range from 30° to 60° with respect to one another.

86. The metal matrix composite article according to claim 82 wherein the first and second directions are oriented in the range from 40° to 50° with respect to one another.

87. The metal matrix composite article according to claim 82 further comprising a third ply comprised of substantially continuous, longitudinally aligned, ceramic oxide fibers having lengths of at least 5 cm, wherein the substantially continuous, longitudinally aligned, ceramic oxide fibers of the third ply have lengths that extend in a third direction, and wherein the third direction is oriented in the range from greater than 0° to 90° with respect to at least one of the first or second directions.

88. The metal matrix composite article according to claim 82 wherein the substantially continuous ceramic oxide fibers have lengths of at least 10 cm.

89. The metal matrix composite article according to claim 82 wherein a portion of the porous ceramic oxide material is between the first and second plies.

90. The metal matrix composite article according to claim 82 wherein the porous ceramic oxide material of the second ceramic article is comprised of alpha alumina.

91. The metal matrix composite article according to claim 82 wherein the article is a brake caliper.

92. A disc brake for a motor vehicle comprising a rotor; inner and outer brake pads disposed on opposite sides of the rotor and movable into braking engagement therewith; a piston for urging the inner brake pad against the rotor; and the brake caliper according to claim 91 comprising a body member having a cylinder positioned on one side of the rotor and containing the piston, an arm member positioned on the other side of the rotor and supporting the outer brake pad, and a bridge extending between the body member and the arm member across the plane of the rotor.

93. The metal matrix composite article according to claim 82 wherein at least a portion of the substantially continuous ceramic oxide fibers is in the form of tows.

94. The metal matrix composite article according to claim 82 wherein the porous ceramic oxide material has an open porosity of at least 85% by volume.

95. The metal matrix composite article according to claim 94 wherein at least a portion of the substantially continuous ceramic oxide fibers is in the form of tows.

96. The metal matrix composite article according to claim 93 wherein the first and second directions are oriented in the range from 30° to 60° with respect to one another.

97. The metal matrix composite article according to claim 93 further comprising a third ply comprised of substantially continuous, longitudinally aligned, ceramic oxide fibers having lengths of at least 5 cm, wherein the substantially continuous, longitudinally aligned, ceramic oxide fibers of the third ply have lengths that extend in a third direction, and wherein the third direction is oriented in the range from greater than 0° to 90° with respect to at least one of the first or second directions.

98. The metal matrix composite article according to claim 93 wherein the porous ceramic oxide material of the second ceramic article is comprised of alpha alumna.

99. The metal matrix composite article according to claim 93 wherein the article is a brake caliper.

100. A disc brake for a motor vehicle comprising a rotor; inner and outer brake pads disposed on opposite sides of the rotor and movable into braking engagement therewith; a piston for urging the inner brake pad against the rotor; and the brake caliper according to claim 99 comprising a body member having a cylinder positioned on one side of the rotor and containing the piston, an arm member positioned on the other side of the rotor and supporting the outer brake pad, and a bridge extending between the body member and the arm member across the plane of the rotor.

101. The metal matrix composite article according to claim 94 wherein the first and second directions are oriented in the range from 30° to 60° with respect to one another.

102. The metal matrix composite article according to claim 94 further comprising a third ply comprised of substantially continuous, longitudinally aligned, ceramic oxide fibers having lengths of at least 5 cm, wherein the substantially continuous, longitudinally aligned, ceramic oxide fibers of the third ply have lengths that extend in a third direction, and wherein the third direction is oriented in the range from greater than 0° to 90° with respect to at least one of the first or second directions.

103. The metal matrix composite article according to claim 94 wherein the porous ceramic oxide material of the second ceramic article is comprised of alpha alumina.

104. The metal matrix composite article according to claim 94 wherein the article is a brake caliper.

105. A disc brake for a motor vehicle comprising a rotor; inner and outer brake pads disposed on opposite sides of the rotor and movable into braking engagement therewith; a piston for urging the inner brake pad against the rotor; and the brake caliper according to claim 104 comprising a body member having a cylinder positioned on one side of the rotor and containing the piston, an arm member positioned on the other side of the rotor and supporting the outer brake pad, and a bridge extending between the body member and the arm member across the plane of the rotor.

106. The metal matrix composite article according to claim 95 wherein the first and second directions are oriented in the range from 30° to 60° with respect to one another.

107. The metal matrix composite article according to claim 95 further comprising a third ply comprised of substantially continuous, longitudinally aligned, ceramic oxide fibers having lengths of at least 5 cm, wherein the substantially continuous, longitudinally aligned, ceramic oxide fibers of the third ply have lengths that extend in a third direction, and wherein the third direction is oriented in the range from greater than 0° to 90° with respect to at least one of the first or second directions.

108. The metal matrix composite article according to claim 95 wherein the porous ceramic oxide material of the second ceramic article is comprised of alpha alumina.

109. The metal matrix composite article according to claim 95 wherein the article is a brake caliper.

110. A disc brake for a motor vehicle comprising a rotor; inner and outer brake pads disposed on opposite sides of the rotor and movable into braking engagement therewith; a piston for urging the inner brake pad against the rotor; and the brake caliper according to claim 109 comprising a body member having a cylinder positioned on one side of the rotor and containing the piston, an arm member positioned on the other side of the rotor and supporting the outer brake pad, and a bridge extending between the body member and the arm member across the plane of the rotor.
